(19) United States
(12) Patent Application Publication
(10) Pub. No.: US 2015/0360985 A1
(43) Pub. Date: Dec. 17, 2015

(54) AQUEOUS TREATMENT SYSTEM

(71) Applicants: MICHAEL PAUL CLEMENTS, Orange, CA (US); CRAIG MILLER, San Clemente, CA (US)

(72) Inventors: MICHAEL PAUL CLEMENTS, Orange, CA (US); CRAIG MILLER, San Clemente, CA (US)

(21) Appl. No.: 14/307,047

(22) Filed: Jun. 17, 2014

(51) Int. Cl. C02F 9/00; C02F 1/46; C02F 1/04

(52) U.S. Cl. CPC C02F 9/00; C02F 1/048; C02F 1/4608; C02F 2103/023

(57) ABSTRACT

The present invention relates generally to a water treatment system that uses an electrostatic field generating plate. Such electrostatic field is then used by an electrostatic water purification process for mass cooling systems to reduce scaling.

### TECHNICAL FIELD

The present invention relates generally to a water treatment system that uses an electrostatic field generating plate. Such electrostatic field is then used by an electrostatic water purification process for mass cooling systems to reduce scaling.

### BACKGROUND

Typically, large cooling apparatus are needed for high volume air conditioning products, large refrigeration products, and any product that requires the dissipation of large amounts of waste heat. Such large cooling apparatus like cooling towers and large heat exchangers cool by way of exchanging the heat. The most common known method of exchanging the heat is performed by the use of water in a heat exchanger where cooling water is passed along side pipes that contain hot water or a water based solution where the heat from the hot water is transferred into the cool water.

Although this is an effective way to transfer the heat, often times the cooling water reaches such a high temperature point that it evaporates which creates steam that needs to be vented out of the system. In this event, additional cooling water needs to be added to the system to keep the system operable.

The known problem with these cooling systems that occurs when using cooling water is an effect called scaling. Scaling occurs when the minerals and other debris within the water that is used for cooling water attaches to the pipes within the cooling system and the heat exchanger eventually causing the blockage of cooling water within the system. If not cleaned, the blockage caused by scaling will cause the cooling system to become inoperable thereby causing the system that needs to displace large amounts of heat to also fail.

Through the years there have been many solutions created to reduce or control the scaling but often they require the use of harsh chemicals that also damage the pipes within the cooling system as they prevent scaling.

An electrostatic water treatment solution for large cooling apparatus was invented and taught in U.S. Pat. No. 4,073,713 by Eldon Means “Means etal.” This electrostatic water system teaches the use of an electric field as a method for controlling the minerals within the water such that they do not cause scaling. Unfortunately, the system was difficult and costly to manufacture due to the precise metal welding needed to produce a device that would generate an electric field while submersible in water. Also, failure of the electrostatic field would cause the cooling system to fail which can result in costly consequences in the event refrigeration is required to support human life at hospitals and food at grocery stores.

### SUMMARY

The deficiencies of the prior art are substantially overcome in consideration of the invention disclosed herein. More specifically, additional innovation and advantages are realized when smartly configuring an electrostatic field generator to charge minerals within water for a water treatment system for a large cooling apparatus.

In the present invention disclosed herein, an aqueous treatment system for a large cooling apparatus is used whereby the aqueous treatment system uses a number of treatment stations to treat an aqueous solution which thereby cools the large cooling apparatus. The number of treatment stations includes a charging station, mineral collection station, a heat exchanging station, an evaporation station, and a replenishing station. Pressure generated by a pump transports an aqueous solution to each of the treatment stations whereby heat and minerals are controlled throughout the aqueous treatment system without the need of chemicals.

One of the more particularly innovative aspects of the aqueous treatment system is the use of an electrostatic field generator to control and remove minerals from the aqueous solution. More specifically, an electrostatic field generating plate is used within the aqueous treatment system to generate an electrostatic field while allowing the aqueous solution to pass over the faces of the plate thereby presenting the aqueous solution to an electrostatic charge of a predetermined polarity. This thereby charges the minerals within the aqueous solution to the desired polarity. The desired voltage used to produce the electrostatic field is between +−25 kV and +−60 kV with the optimum voltage of 35 kV. The electrostatically charged minerals along with the aqueous solution are then carried by way of a pump to a mineral collection station. The mineral collection station presents an opposite polarity charge thereby overcoming the attraction forces between the aqueous solution and the minerals such that the minerals collect in the discharge collection area while the mineral free aqueous solution continues to the heat exchanging station where a heat exchanger is provided to transfer heat from the freon gasses to the aqueous solution.

Another innovative aspect of the present invention is the ability to add water that contains minerals to the aqueous solution. In one embodiment of the aqueous treatment system, the aqueous solution is transported by way of pressure generated by a pump from the heat exchanging station to an evaporation station where any vapors created by the evaporation of water from the aqueous solution are vented while the aqueous solution continues on to a replenishing station. The replenishing station is configured such that latent-mineral water can be added to replenish the aqueous solution. Replenishing the aqueous solution with latent-mineral water enables one to take fresh water from various sources like wells, lakes, or even municipalities and without treating the water with chemicals to control the minerals such that they do not cause scaling.

Another particularly innovative aspect of the present invention is the electrostatic field generating plate of the aqueous treatment system. The electrostatic field generating plate consists of two polyvinyl chloride (PVC) plates that house a conductive layer which is coupled to a potential power source enabled to provide a potential level of charge such to be sufficient to charge the materials within the aqueous solution. Additionally, the conductive layer is electrically coupled to a charging supply to control the potential level of the charge applied to the conductive layer. Additionally the polyvinyl chloride exterior shell is sealed with a non-conductive high stress bonding adhesive much like non-conductive adhesive resin. The potential level of charges should be sufficient to charge the minerals within the aqueous solution. The use of the PVC along with the non-conductive high stress bonding adhesive enables a simpler and cheaper production process alleviating the need for expensive metal and welding that is prone to leaks.

Another innovative aspect of the present invention is realized when a plurality of electrostatic field generating plates are used in a system whereby each electrostatic field generating plate is electrically connected to a dedicated and isolated output of a charging source. More specifically, due to the significantly reduced production costs, a plurality of plates can be used in a system. The advantage of using a plurality of plates that are electrically connected to a dedicated and isolated output of a charging source enables the aqueous treatment system to continue in the event any one plate fails.

### BRIEF DESCRIPTION OF THE DRAWINGS

FIG. 1 illustrates the aqueous system of the present invention.

FIG. 2 illustrates an electric field generating plate of the present invention.

FIG. 3 illustrates the charging station of the aqueous system of the present invention.

FIG. 4 illustrates the method of charging with multiple field generating plates of the present invention.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an aqueous treatment system for cooling large cooling apparatus. The particularly innovative aspect of the present invention is that the system is enabled to control the minerals within the aqueous solution without the addition of chemicals by way of an electric field generating plate that reduces the complexity and cost of manufacturing a field generating means thereby enabling the broadened use of the electrostatic water treatment solution over the chemical water treatment solutions prevalent today.

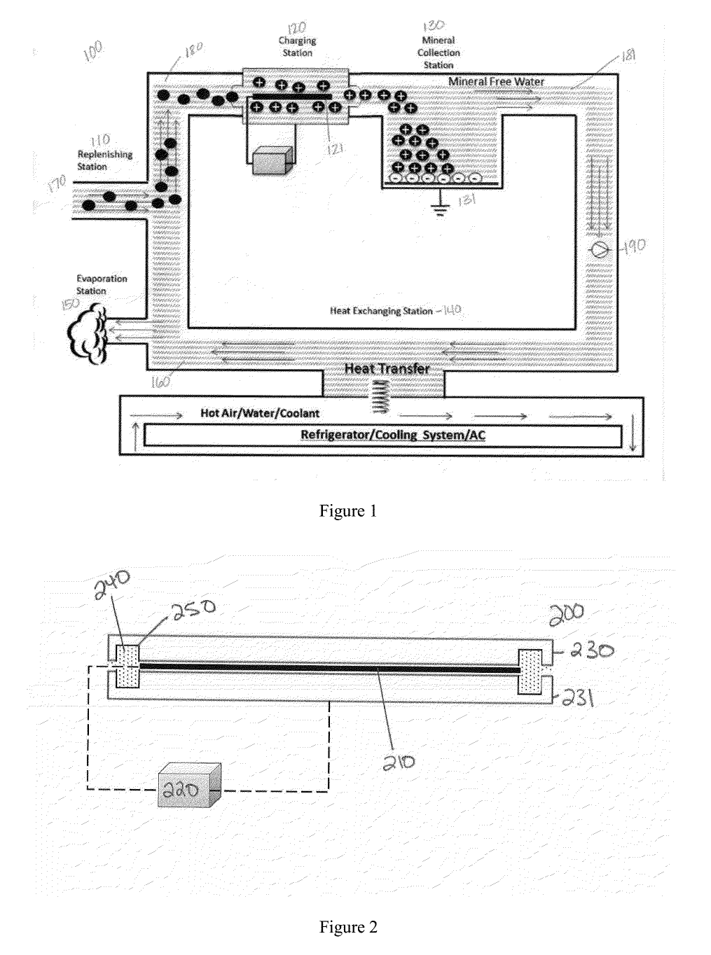

In the present invention, an aqueous treatment system is disclosed for a large cooling apparatus that has a number of aqueous treatment stations that control the heat and the minerals within the aqueous treatment system. The size of the aqueous treatment system varies in relation to the amount of heat the large cooling apparatus needs to dissipate. Additionally the plate system may include several small plates in one hand or one large plate in another and depends on the space available. As represented in FIG. 1, the aqueous treatment system includes a replenishing station 110, a charging station 120, a mineral collection station 130, a heat exchanging station 140, and an evaporation station 150.

Beginning at the replenishing station 110, where water that includes latent minerals 170 is added to the mineral free aqueous solution 160 and forms a latent-mineral aqueous solution 180. These latent-minerals can vary depending on the source of the water. For for example if the water is provided by a well it may include forms of calcium and silica and if the water is derived from a municipality it may include other debris like plant material and bacteria.

The latent-mineral aqueous solution 180 is then transported to the charging station 120 by way of pressure generated by a pump 190. The charging station includes at least one electric field generating plate system 121 as disclosed in a cross-related U.S. patent application having an application number of 14/306,897 and title “The Method of Producing an Electrostatic Field Generator” of which such disclosure shall be incorporated herein. The electric field generating plate (FIG. 2; 200) is used in the aqueous treatment system to positively charge the latent-minerals 170 of the latent-mineral aqueous solution 180 by means of an electric field at a voltage between +−25 kV and +−60 kV with the optimum voltage of 35 kV.

The positively charged latent-mineral aqueous solution 180 is then transported to a mineral collection station 130. The mineral collection station 130 includes a negatively charged surface 131 which is electrically connected to a ground. Furthermore the mineral collection station 130 is smartly presented to the positively charged latent-mineral aqueous solution 180 such that the voltage potential between the positively charged latent-mineral located in the aqueous solution 180 and the negatively charged grounded surface 131 is large enough to separate the latent-mineral from the aqueous solution thereby creating non-latent minerals that form on the grounded surface 131 thereby forming a mineral free aqueous solution 181.

The mineral free aqueous solution 181 is then transported to the heat exchanging station 140 whereby the mineral free aqueous solution is presented to the freon gas of the large cooling apparatus such that heat is transferred from the freon gas to the mineral free aqueous solution. The freon gas is then returned to the large cooling system to transport more heat while the mineral free aqueous solution 160 is transported to the evaporation station 150 by means of pressure created by a pump 190.

The evaporation station 150 includes a valve (not shown) that releases vapor created by the evaporation of water due to heating the mineral free aqueous solution. The release of vapor causes a reduction of heat and the reduction of aqueous solution by volume in the aqueous treatment system.

The aqueous solution 181 is then transported to the replenishing station 110 where latent-mineral water can be added to replenish the aqueous solution.

The charging station includes an electric field generating plate 200, as further represented in FIG. 2. The electric field generating plate 200 includes an aluminum sheet 210 that is electrically connected to a charging source 220 and where the aluminum sheet 210 is sandwiched between two separate plates made of PVC 230 and 231 which are water-tightly sealed together with a non-conductive high strength adhesive 240 such that aluminum sheet 210 is held within. Additionally, the PVC plates 230 and 231 include a groove 250 that enables the non-conductive high strength adhesive 240 to expand during the cure process thereby further ensuring a water tight seal around the aluminum sheet 210.

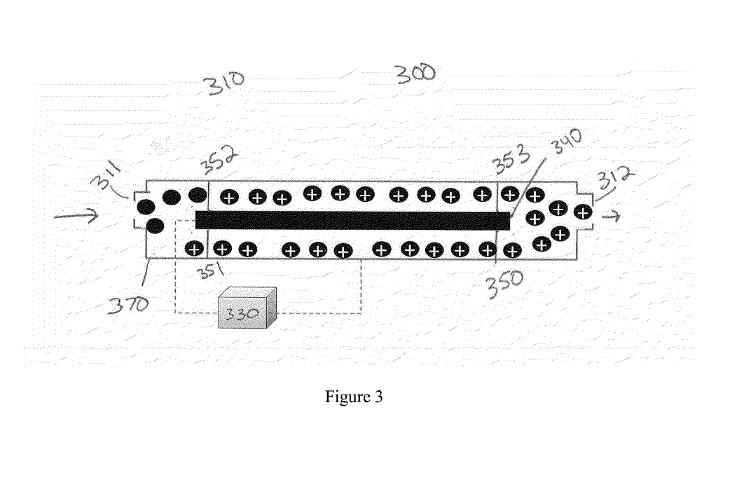

In one embodiment of the charging station 300, as represented in FIG. 3, includes a metal housing 310 and is electrically connected to the charging source 330. An electric field generating plate 340 is mounted within the housing 310 by plate holding brackets 350, 351, 352 and 353. The housing also includes a sealed and isolated connector for electrically connecting the electric field generating plate 340 to the charging source 330. Additionally, the housing 310 has an opening on each end 311 and 312 and it is designed such that the latent-mineral aqueous solution 320 may flow into the housing on the proximal end 311 and out of the housing on the distal end 312 by way of water pressure produced by a pump (not shown).

In operation, a high voltage electric field is generated between the housing and the aluminum sheet (FIG. 2: 210) by way of applying 35 kV of power from the charging source 330. As the latent-mineral aqueous solution 320 passes between the housing 310 and the electric field generating plate 340 at a rate between 10 gallons per minute and 20 gallons per minute with a preferred rate of 14 gallons per minute the latent-minerals within the latent mineral aqueous solution are positively charged. As described above the charged latent-mineral aqueous solution is then transported to the mineral collection station whereby the charged latent-mineral separated from the aqueous solution and collected thereby forming a mineral free aqueous solution.

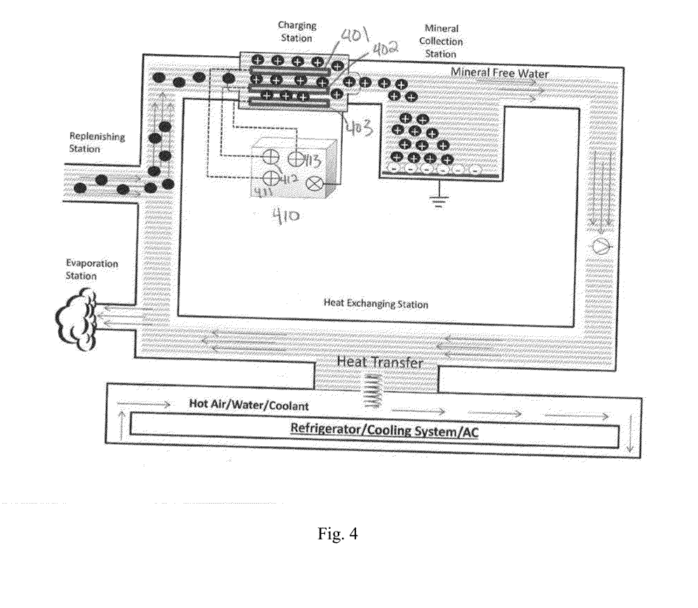

Another particularly innovative embodiment of the present invention is represented in FIG. 4 whereby the aqueous treatment system includes three electric field generating plates 401, 402, and 403. Furthermore, the aqueous treatment system includes a charging source 410 that has three independent and isolated outputs 411, 412 and 413 which are electrically independently connected to each of the three electric field generating plates. In practice, if the electric field generating plate 401 became inoperable or even worse created an electrical short the charging source 410 is electrically fused such that the failure including an electrical short is isolated from the independent and isolated outputs of 412 and 413. This enables the charging source 410 to continue supplying power to the electric field generating plates 402 and 403 by way of the independently connected and isolated outputs of 412 and 413 of the charging source 410.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the disclosure can be modified, if necessary, with various configurations, and concepts of the various patents, applications, and publications to provide yet further embodiments of the disclosure.

What is claimed is:

1. An aqueous treatment system for a large cooling apparatus, substantially consisting of:
a latent-mineral aqueous solution;
at least one charging station for charging the latent-minerals; and
a collection station for separating the charged latent-minerals from the aqueous solution.

2. An aqueous treatment system of claim 1, wherein the charging station includes housing and at least one electric field generating plate.

3. An aqueous treatment system of claim 2, wherein the electric field generating plate and charging station are electrically connected to a charging source.

4. An aqueous treatment system of claim 3, wherein an electric field is generated between the housing and the electric field generating plate at a voltage between +−25 kV and +−60 kV.

5. An aqueous treatment system for a large cooling apparatus, substantially consisting of:
a latent-mineral aqueous solution;
a replenishing station;
at least one charging station for charging the latent-minerals;
a collection station for separating the charged latent-minerals from the aqueous solution;
a heat exchanging station; and
an evaporation station

6. An aqueous treatment system of claim 5, wherein the charging station includes housing and at least one electric field generating plate.

7. An aqueous treatment system of claim 6, wherein the electric field generating plate and charging station are electrically connected to a charging source.

8. An aqueous treatment system of claim 7, wherein an electric field is generated between the housing and the electric field generating plate at a voltage between +−25 kV and +−60 kV.

9. An aqueous treatment system for a large cooling apparatus, substantially consisting of:
a charging station that includes a plurality of field generating plates; and
a charging source that includes a plurality of isolated outputs whereby at least one field generating plate is independently connected to at least one isolation output.
